(19) United States
(12) Patent Application Publication
(10) Pub. No.: US 2015/0014581 A1
(43) Pub. Date: Jan. 15, 2015

(54) POSITIVE ELECTRODE ACTIVE MATERIAL AND SECONDARY BATTERY

(71) Applicant: SEMICONDUCTOR ENERGY LABORATORY CO., LTD., Atsugi-shi (JP)

(72) Inventors: Takahiro KAWAKAMI, Atsugi (JP); Shuhei YOSHITOMI, Ayase (JP); Teruaki OCHIAI, Atsugi (JP); Yumiko SAITO, Atsugi (JP); Yohei MOMMA, Isehara (JP); Satoshi SEO, Sagamihara (JP)

(21) Appl. No.: 14/328,251

(22) Filed: Jul. 10, 2014

(30) Foreign Application Priority Data
Jul. 15, 2013 (JP) 2013-147169
Aug. 23, 2013 (JP) 2013-172853

(51) Int. Cl. H01M 4/505; H01M 4/36; H01M 4/58

(52) U.S. Cl. CPC H01M 4/505; H01M 4/5825; H01M 4/36
USPC 252/182.1

(57) ABSTRACT

A positive electrode active material that achieves high capacity and high energy density of a secondary battery is provided. The positive electrode active material is represented by Li₂Mn_{1-X}A_{X}O₃ and contains a metal element, Si, or P as A. The positive electrode active material has higher discharge capacity than Li₂MnO₃.

### TECHNICAL FIELD

One embodiment of the present invention relates to an object, a method, and a manufacturing method. One embodiment of the present invention relates to a process, a machine, manufacture, and a composition of matter. One embodiment of the present invention relates to a semiconductor device, a display device, a light-emitting device, a power storage device, a driving method thereof, and a manufacturing method thereof. One embodiment of the present invention relates to a positive electrode active material, a secondary battery, and a manufacturing method thereof. One embodiment of the present invention relates to a positive electrode active material of a lithium-ion secondary battery.

### BACKGROUND ART

Examples of the secondary battery include a nickel-metal hydride battery, a lead-acid battery, and a lithium-ion secondary battery.

Such secondary batteries are used as power sources in portable information terminals typified by mobile phones. In particular, lithium-ion secondary batteries have been actively developed because capacity thereof can be increased and size thereof can be reduced.

As a positive electrode active material that achieves high capacity, a solid solution obtained by mixing a first alkali metal oxide and a second alkali metal oxide having higher electric conductivity than the first alkali metal oxide has been disclosed (Patent Document 1).

### REFERENCE

[Patent Document 1] Japanese Published Patent Application No. 2011-216476

### DISCLOSURE OF INVENTION

An object is to provide a positive electrode active material that can be formed at low cost with the use of manganese, which is an inexpensive material.

Another object is to increase the amount of lithium ions that can be received and released in and from a positive electrode active material to achieve high capacity and high energy density of a secondary battery.

Another object is to provide a novel positive electrode active material. Another object is to provide a novel power storage device.

High ion conductivity and high electric conductivity are required as properties of a positive electrode active material of a lithium-ion secondary battery. Thus, another object is to provide a positive electrode active material having high ion conductivity and high electric conductivity.

Note that the descriptions of these objects do not disturb the existence of other objects. In one embodiment of the present invention, there is no need to achieve all the objects. Other objects will be apparent from and can be derived from the descriptions of the specification, the drawings, the claims, and the like.

The present inventors have found that Li₂MnO₃ in which part of Mn is substituted by another metal element, namely Li₂Mn_{1-X}A_{X}O₃ can be provided as a novel positive electrode active material that is capable of increasing battery capacity. Here, “A” represents silicon (Si), phosphorus (P), or a metal element other than lithium (Li) and manganese (Mn). Note that X is greater than 0 and less than 1, preferably greater than 0 and less than 0.5.

Furthermore, A is preferably a metal element selected from Ni, Ga, Fe, Mo, In, Nb, Nd, Co, Sm, Mg, Al, Ti, Cu, and Zn, Si, or P.

The use of a material expressed by Li₂Mn_{1-X}A_{X}O₃ as a positive electrode active material of a lithium-ion secondary battery can increase the capacity and energy density of the secondary battery.

The positive electrode active material disclosed in this specification can be formed through a simple forming process where a plurality of materials are weighed, pulverized in a ball mill or the like, and mixed, and then the mixture is fired; thus, cost reduction and excellent mass productivity are achieved.

According to one embodiment of the present invention, a positive electrode active material that can be formed at low cost can be provided.

According to another embodiment of the present invention, a positive electrode active material with high ion conductivity and high electric conductivity can be provided.

According to another embodiment of the present invention, a novel positive electrode active material can be provided.

According to another embodiment of the present invention, a secondary battery that has high battery capacity and high energy density can be provided.

Note that one embodiment of the present invention is not limited to these effects. For example, depending on circumstances or conditions, one embodiment of the present invention might produce another effect. Furthermore, depending on circumstances or conditions, one embodiment of the present invention might not produce any of the above effects.

### BRIEF DESCRIPTION OF DRAWINGS

In the accompanying drawings:

FIG. 1 is a graph showing the relation between discharge capacity and voltage of one embodiment of the present invention;

FIG. 2 shows X-ray diffraction data of one embodiment of the present invention;

FIG. 3 shows X-ray diffraction data of one embodiment of the present invention;

FIG. 4 is a graph showing the relation between discharge capacity and voltage of one embodiment of the present invention;

FIG. 5 is a graph showing the relation between discharge capacity and voltage of one embodiment of the present invention;

FIG. 6 shows X-ray diffraction data of one embodiment of the present invention;

FIG. 7 shows X-ray diffraction data of one embodiment of the present invention;

FIGS. 8A to 8C illustrate a coin-type secondary battery;

FIG. 9 illustrates a laminated secondary battery;

FIGS. 10A and 10B illustrate a cylindrical secondary battery;

FIGS. 11A and 11B illustrate an example of a power storage unit;

FIGS. 12A1, 12A2, 12B1, and 12B2 each illustrate an example of a power storage unit;

FIGS. 13A and 13B each illustrate an example of a power storage unit;

FIGS. 14A and 14B each illustrate an example of a power storage unit;

FIG. 15 illustrates an example of a power storage unit;

FIGS. 16A and 16B illustrate an example of an electrical appliance;

FIG. 17 illustrates an example of an electrical appliance;

FIGS. 18A and 18B each illustrate an example of an electrical appliance;

FIGS. 19A and 19B illustrate an example of an electrical appliance;

FIG. 20 illustrates an example of an electrical appliance;

FIG. 21 illustrates examples of electrical appliances; and

FIGS. 22A and 22B illustrate an example of an electrical appliance.

### BEST MODE FOR CARRYING OUT THE INVENTION

Embodiments of the present invention will be described below in detail with reference to the drawings. However, the present invention is not limited to the following descriptions, and it is easily understood by those skilled in the art that modes and details disclosed herein can be modified in various ways. Furthermore, the present invention is not construed as being limited to descriptions of the embodiments.

### Embodiment 1

An example of a method for synthesizing Li₂Mn_{1-X}A_{X}O₃ will be described below. Table 1 shows Li materials, Mn materials, and A materials for forming Comparative Sample 100 and Samples 101 to 116. In this embodiment, Comparative Sample 100 and Samples 101 to 116 are formed using respective combinations of materials shown in Table 1.

TABLE 1

| | Li material | Mn mateiral | A material |
|---|---|---|---|
| Sample 100 | Li₂CO₃ | MnCO₃ | — |
| Sample 101 | Li₂CO₃ | MnCO₃ | NiO |
| Sample 102 | Li₂CO₃ | MnCO₃ | Ga₂O₃ |
| Sample 103 | Li₂CO₃ | MnCO₃ | FeC₂O₄ |
| Sample 104 | Li₂CO₃ | MnCO₃ | MoO₃ |
| Sample 105 | Li₂CO₃ | MnCO₃ | In₂O₃ |
| Sample 106 | Li₂CO₃ | MnCO₃ | Nb₂O₅ |
| Sample 107 | Li₂CO₃ | MnCO₃ | Nd₂O₃ |
| Sample 108 | Li₂CO₃ | MnCO₃ | Co₃O₄ |
| Sample 109 | Li₂CO₃ | MnCO₃ | Sm₂O₃ |
| Sample 110 | Li₂CO₃ | MnCO₃ | NH₄H₂PO₄ |
| Sample 111 | Li₂CO₃ | MnCO₃ | MgO |
| Sample 112 | Li₂CO₃ | MnCO₃ | SiO₂ |
| Sample 113 | Li₂CO₃ | MnCO₃ | Al₂O₃ |
| Sample 114 | Li₂CO₃ | MnCO₃ | Ti₂O₃ |
| Sample 115 | Li₂CO₃ | MnCO₃ | CuO |
| Sample 116 | Li₂CO₃ | MnCO₃ | ZnO |

First, the materials shown in Table 1 are used as a Li material, a Mn material, and an A material and are weighed. In this embodiment, X of the samples is 0.1. Thus, the ratio of the materials is adjusted so that the molar ratio of Li:Mn:A in the formed sample is 2:0.9:0.1. For example, in the case of forming Sample 101, the materials are weighed so that the molar ratio of Li₂CO₃ (lithium carbonate):MnCO₃ (manganese carbonate):NiO (nickel oxide)=1:0.9:0.1. In the case of forming Sample 102, the materials are weighed so that the molar ratio of Li₂CO₃:MnCO₃:Ga₂O₃ (gallium oxide)=1:0.9:0.05. Note that methods for forming Comparative Sample 100 and Samples 101 to 116 are the same except that the ratios of materials are different.

Then, acetone is added to the materials and then mixing is performed in a ball mill to form a mixed material. In this embodiment, the weighed materials, a zirconia ball with a diameter of 3 mm, and acetone are put into a pot made of zirconia, and wet milling in a planetary ball mill is performed at 400 rpm for 2 hours.

After that, heating is performed to volatilize acetone, so that a mixed material is obtained. In this embodiment, heating of the slurry is performed at 50° C. in the air to volatilize acetone after the ball milling, so that a mixed material is obtained.

Then, the mixed material is put into a melting pot, and is fired at a temperature in the range from 500° C. to 1000° C. in the air for 5 to 20 hours inclusive to synthesize a novel material. In this embodiment, a melting pot made of alumina is filled with the mixed material that has been dried, and heating is performed at 900° C. for 10 hours.

Subsequently, grinding is performed to separate the sintered particles. In this embodiment, the fired material, a zirconia ball with a diameter of 3 mm, and acetone are put into a pot made of zirconia, and wet milling in a planetary ball mill is performed at 200 rpm for 2 hours.

After the grinding, heating is performed to volatilize acetone, and then, vacuum drying is performed, so that a powdery novel material is obtained. In this embodiment, heating of the slurry is performed at 50° C. in the air to volatilize acetone after the grinding, and then, vacuum drying is performed at 170° C.

The use of the formed novel material (Samples 101 to 116) as a positive electrode active material enables fabrication of a favorable secondary battery.

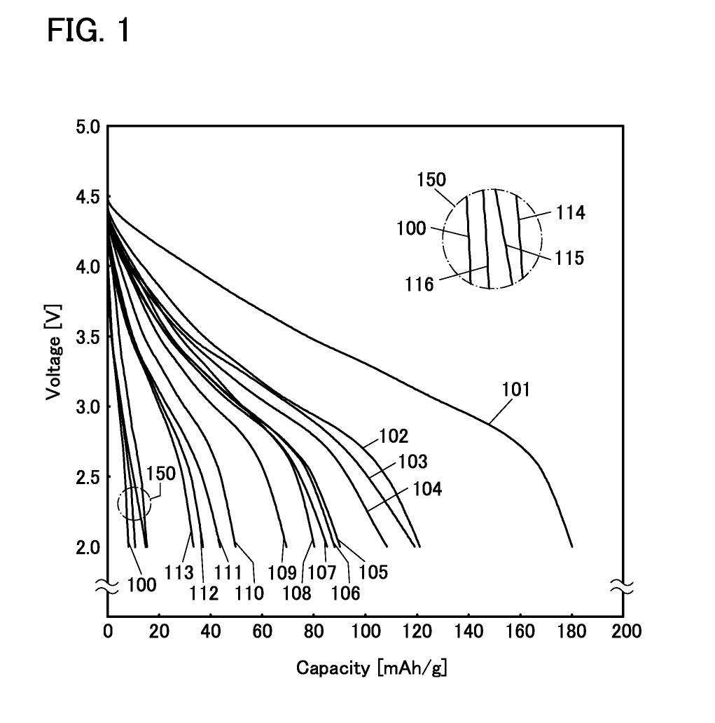

FIG. 1 shows measurement results of the discharge capacity of Comparative Sample 100 and Samples 101 to 116. An enlarged view of a part 150 of the graph is shown in the upper right in FIG. 1.

According to FIG. 1, Samples 101 to 116 have higher discharge capacity than Comparative Sample 100. In particular, Sample 101, which contains Ni as A, has the highest discharge capacity.

In the case of using Li₂Mn_{1-X}A_{X}O₃, the positive electrode active material disclosed in this specification and the like, for a secondary battery, the number of Li atoms is changed in the range from 0 to 2 by charge operation or discharge operation. Thus, Li₂Mn_{1-X}A_{X}O₃ can be represented as Li_{Y}Mn_{1-X}A_{X}O₃ (0≦Y≦2).

A is not necessarily one kind of element and may be two or more kinds of elements.

The use of the positive electrode active material disclosed in this embodiment enables fabrication of a secondary battery having high discharge capacity. Furthermore, the use of the positive electrode active material disclosed in this embodiment enables fabrication of a secondary battery having high battery capacity and high energy density.

This embodiment can be implemented in combination with any of the other embodiments as appropriate.

### Embodiment 2

In this embodiment, X-ray diffraction (XRD) measurement results and discharge capacity measurement results of Sample 201, where A is Ni and X is 0.3, and Comparative Sample 100 and Sample 101 described in the above embodiment will be described. Sample 101 is a sample where A is Ni and X is 0.1. Comparative Sample 100, Sample 101, and Sample 201 in this embodiment can be fabricated by the fabrication method described in the above embodiment.

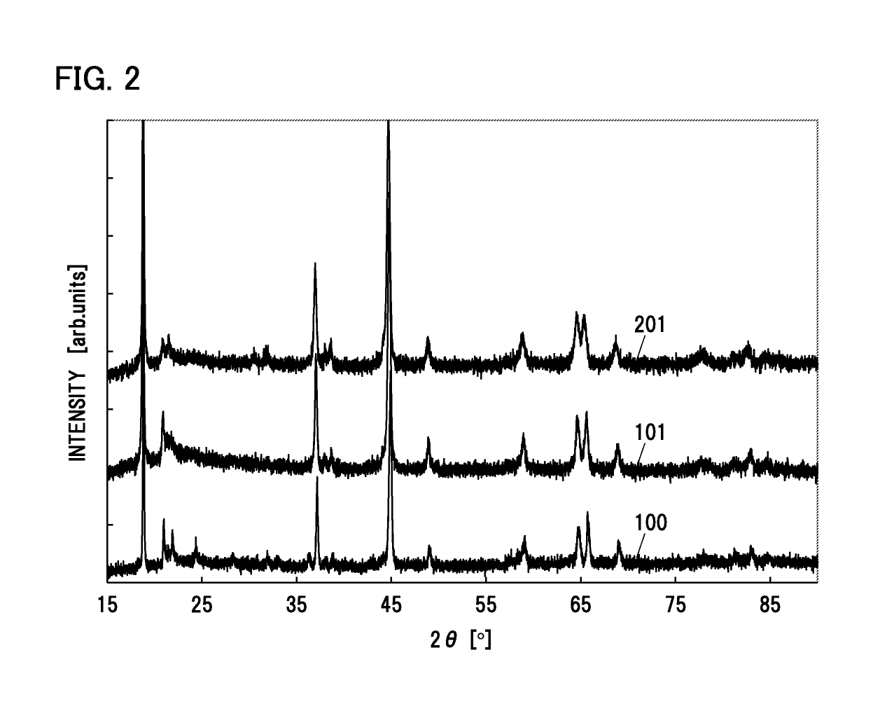

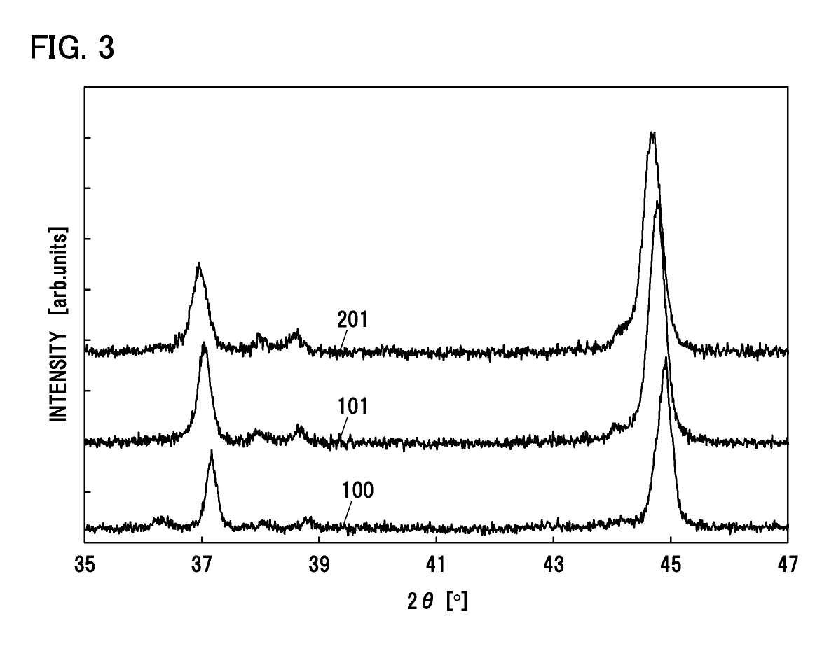

FIGS. 2 and 3 show XRD measurement results. Note that a graph of FIG. 2 shows data of all of Comparative Sample 100 and Samples 101 and 201, for comparison.

FIG. 2 shows that both of Samples 101 and 201 have diffraction peaks similar to those of Comparative Sample 100. Diffraction peaks of Samples 101 and 201 significantly different from those of Comparative Sample 100 are not observed.

FIG. 3 is an enlarged graph showing diffraction peaks around 2θ=37° and 2θ=45°. Note that the graph of FIG. 3 shows data of all of Comparative Sample 100 and Samples 101 and 201, for comparison. It can be found from FIG. 3 that the positions of diffraction peaks differ depending on X. The variation in diffraction peak position implies that the lattice constants of Comparative Sample 100 and Samples 101 and 201 are different.

FIGS. 2 and 3 suggest that Ni used to form Samples 101 and 201 is favorably substituted by Mn in Li₂MnO₃.

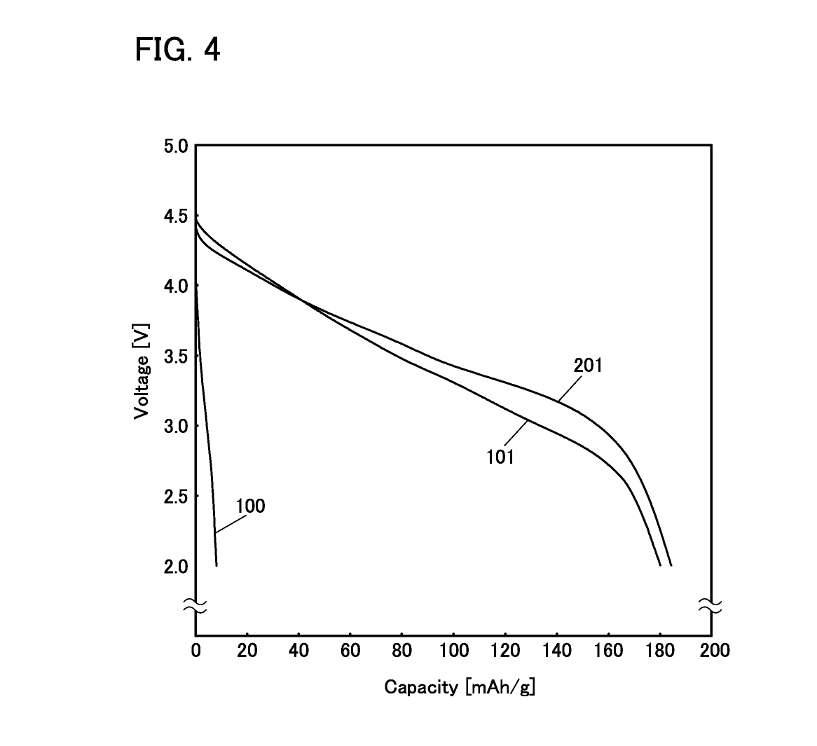

FIG. 4 shows measurement results of the discharge capacity of Comparative Sample 100 and Samples 101 and 201. Samples 101 and 201 have higher discharge capacity than Comparative Sample 100. Furthermore, Sample 201, where X is 0.3, has higher discharge capacity than Sample 101, where X is 0.1.

The use of the positive electrode active material disclosed in this embodiment enables fabrication of a secondary battery having high discharge capacity. Furthermore, the use of the positive electrode active material disclosed in this embodiment enables fabrication of a secondary battery having high battery capacity and high energy density.

This embodiment can be implemented in appropriate combination with any of the other embodiments.

### Embodiment 3

In this embodiment, XRD measurement results and charge and discharge capacity measurement results of Comparative Sample 700, which is a positive electrode active material represented by Li₂Mn_{1-X}Ni_{X}O₃ where X is O, and Sample 701, which is a positive electrode active material represented by Li₂Mn_{1-X}Ni_{X}O₃ where X is 0.01, will be described.

An example of a method for synthesizing Li₂Mn_{1-X}Ni_{X}O₃ will be described below. Table 2 shows Li materials, Mn materials, and Ni materials for forming Comparative Sample 700 and Sample 701. In this embodiment, Comparative Sample 700 and Sample 701 are formed using respective combinations of materials shown in Table 2.

TABLE 2

| | Li Material | Mn Material | Ni Material |
|---|---|---|---|
| Sample 700 | Li₂CO₃ | MnCO₃ | — |
| Sample 701 | Li₂CO₃ | MnCO₃ | NiO |

First, the materials shown in Table 2 are used as a Li material, a Mn material, and a Ni material and are weighed. In this embodiment, X of the samples is 0.01. Thus, the ratio of the materials is adjusted so that the molar ratio of Li:Mn:Ni in the formed sample is 2:0.99:0.01. For example, in the case of forming Sample 701, the materials are weighed so that the molar ratio of Li₂CO₃ (lithium carbonate):MnCO₃ (manganese carbonate):NiO (nickel oxide)=1:0.99:0.01. In the case of forming Comparative Sample 700, the materials are weighed so that the molar ratio of Li₂CO₃:MnCO₃=1:1. Note that methods for forming Comparative Sample 700 and Sample 701 are the same except that the ratios of materials are different.

Then, acetone is added to the materials and then mixing is performed in a ball mill to form a mixed material. In this embodiment, the weighed materials, a zirconia ball with a diameter of 3 mm, and acetone are put into a pot made of zirconia, and wet milling in a planetary ball mill is performed at 400 rpm for 2 hours.

After that, heating is performed to volatilize acetone, so that a mixed material is obtained. In this embodiment, heating of the slurry is performed at 50° C. in the air to volatilize acetone after the ball milling, so that a mixed material is obtained.

Then, the mixed material is put into a melting pot, and is fired at a temperature in the range from 500° C. to 1000° C. in the air for 5 to 20 hours inclusive to synthesize a novel material. In this embodiment, a melting pot made of alumina is filled with the mixed material that has been dried, and heating is performed at 900° C. for 10 hours.

Subsequently, grinding is performed to separate the sintered particles. In this embodiment, the fired material, a zirconia ball with a diameter of 3 mm, and acetone are put into a pot made of zirconia, and wet milling in a planetary ball mill is performed at 200 rpm for 2 hours.

After the grinding, heating is performed to volatilize acetone, and then, vacuum drying is performed, so that a powdery novel material is obtained. In this embodiment, heating of the slurry is performed at 50° C. in the air to volatilize acetone after the grinding, and then, vacuum drying is performed at 170° C.

The use of the formed novel material (Sample 701) as a positive electrode active material enables fabrication of a favorable secondary battery.

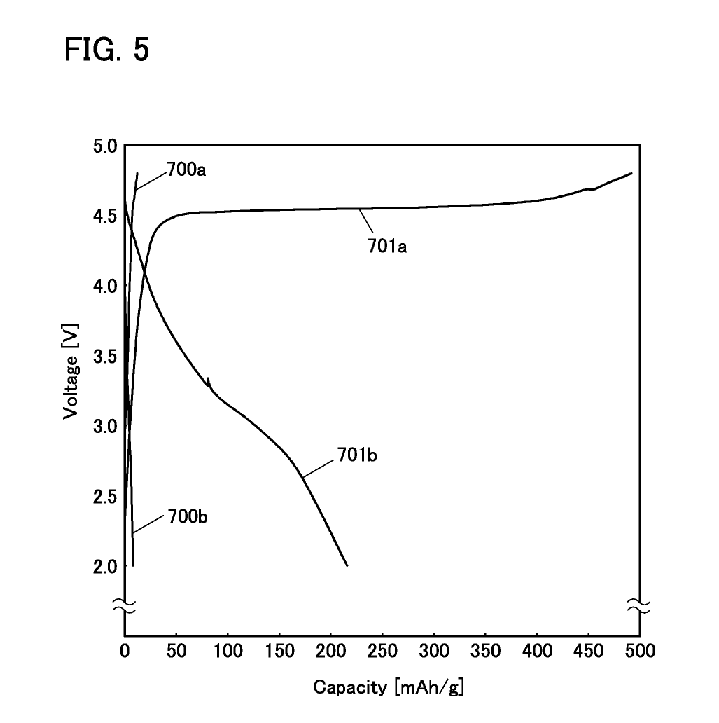

FIG. 5 shows measurement results of the charge capacity and discharge capacity of Comparative Sample 700 and Sample 701. In FIG. 5, curves 700a and 700b indicate changes in the discharge capacity of Comparative Sample 700 and changes in the charge capacity of Comparative Sample 700, respectively, and curves 701a and 701b indicate changes in the discharge capacity of Sample 701 and changes in the charge capacity of Sample 701, respectively. According to FIG. 5, Sample 701 has higher charge capacity and discharge capacity than Comparative Sample 700.

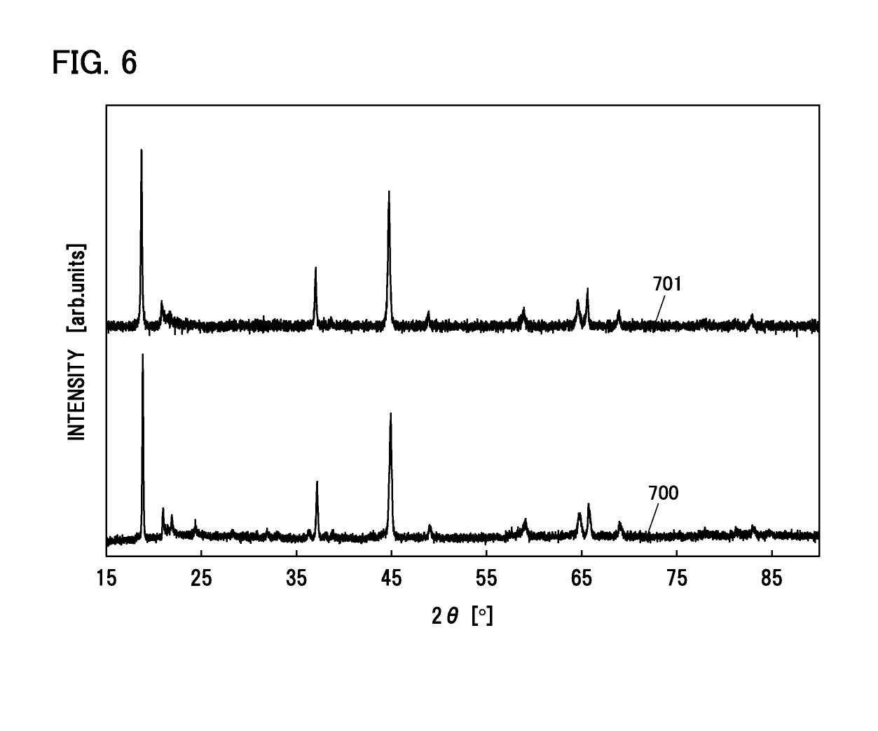

Next, FIG. 6 shows XRD measurement results of Comparative Sample 700 and Sample 701. FIG. 6 shows data of both of Comparative Sample 700 and Sample 701, for comparison.

The XRD measurement results show that Sample 701 has diffraction peaks similar to those of Comparative Sample 700. Diffraction peaks of Sample 701 significantly different from those of Comparative Sample 700 are not observed.

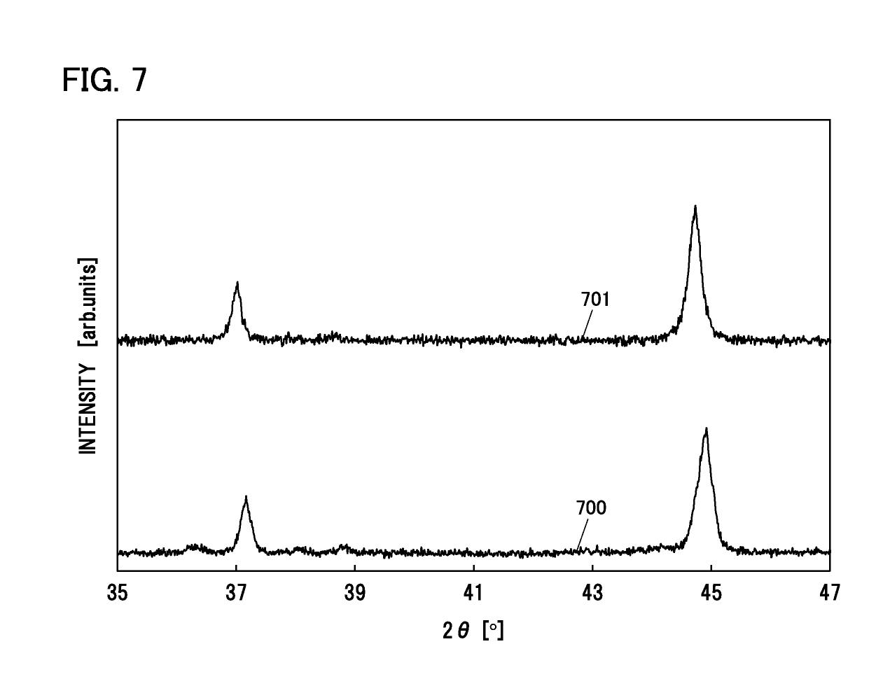

FIG. 7 is an enlarged graph showing diffraction peaks around 2θ=37° and 2θ=45°. Note that the graph of FIG. 7 shows data of both of Comparative Sample 700 and Sample 701, for comparison. In FIG. 7, the positions of diffraction peaks around 2θ=37° and 2θ=45° are different between Comparative Sample 700 and Sample 701. The variation in diffraction peak position implies that the lattice constants of Comparative Sample 700 and Sample 701 are different.

FIGS. 6 and 7 suggest that Ni used to form Sample 701 is favorably substituted by Mn in Li₂MnO₃.

In the case of using Li₂Mn_{1-X}Ni_{X}O₃, the positive electrode active material disclosed in this specification and the like, for a secondary battery, the number of Li atoms is changed in the range from 0 to 2 by charge operation or discharge operation. Thus, Li₂Mn_{1-X}Ni_{X}O₃ can be represented as Li_{Y}Mn_{1-X}Ni_{X}O₃ (0≦Y≦2).

The use of the positive electrode active material disclosed in this embodiment enables fabrication of a secondary battery having high discharge capacity. Furthermore, the use of the positive electrode active material disclosed in this embodiment enables fabrication of a secondary battery having high battery capacity and high energy density.

This embodiment can be implemented in combination with any of the other embodiments as appropriate.

### Embodiment 4

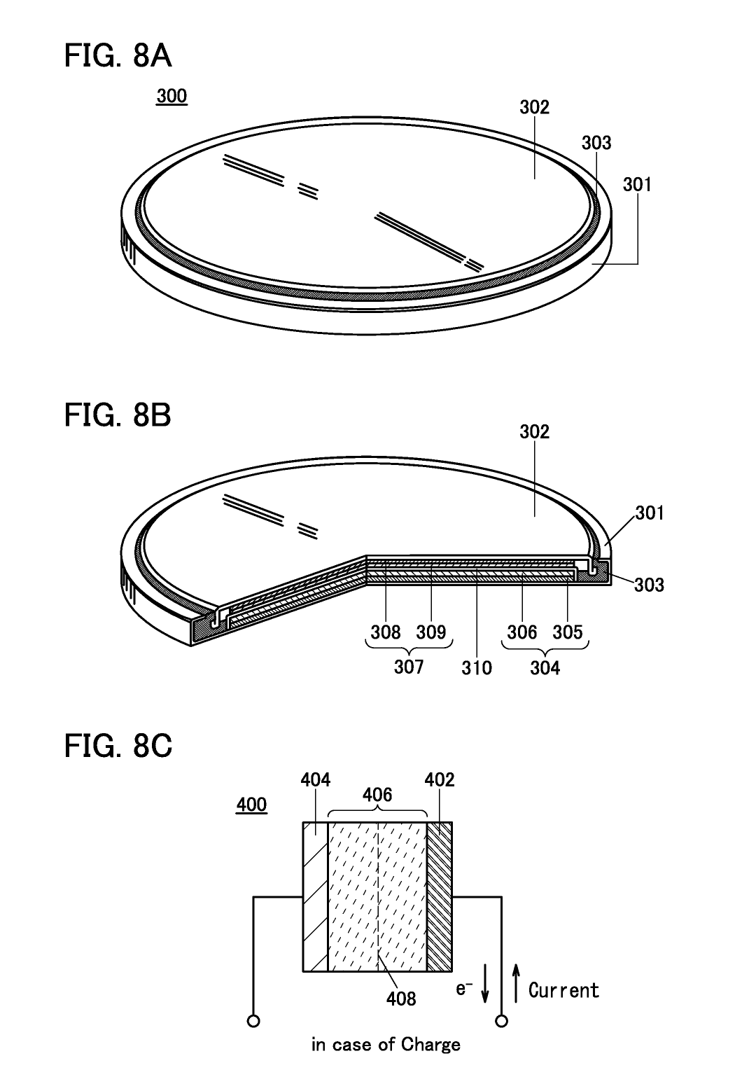

In this embodiment, the structure of a storage battery including the positive electrode active material described in the above embodiment will be described with reference to FIGS. 8A to 8C, FIG. 9, and FIGS. 10A and 10B.

### (Coin-Type Storage Battery)

FIG. 8A is an external view of a coin-type (single-layer flat type) storage battery, and FIG. 8B is a cross-sectional view thereof.

In a coin-type storage battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The positive electrode active material layer 306 may further include a binder for increasing adhesion of positive electrode active materials, a conductive additive for increasing the conductivity of the positive electrode active material layer, and the like in addition to the active materials. As the conductive additive, a material that has a large specific surface area is preferably used; for example, acetylene black (AB) can be used. Alternatively, a carbon material such as a carbon nanotube, graphene, or fullerene can be used.

A negative electrode 307 includes a negative electrode current collector 308 and a negative electrode active material layer 309 provided in contact with the negative electrode current collector 308. The negative electrode active material layer 309 may further include a binder for increasing adhesion of negative electrode active materials, a conductive additive for increasing the conductivity of the negative electrode active material layer, and the like in addition to the negative electrode active materials. A separator 310 and an electrolyte (not illustrated) are provided between the positive electrode active material layer 306 and the negative electrode active material layer 309.

A material with which lithium can be dissolved and precipitated or a material into and from which lithium ions can be inserted and extracted can be used for the negative electrode active materials used for the negative electrode active material layer 309; for example, a lithium metal, a carbon-based material, and an alloy-based material can be used. The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are intercalated into the graphite (while a lithium-graphite intercalation compound is formed). For this reason, a lithium-ion secondary battery can have a high operating voltage. In addition, graphite is preferable because of its advantages such as relatively high capacity per unit volume, small volume expansion, low cost, and safety greater than that of a lithium metal.

For the negative electrode active materials, an alloy-based material which enables charge-discharge reactions by an alloying reaction and a dealloying reaction with lithium metal can be used. In the case where carrier ions are lithium ions, a material containing at least one of Al, Si, Ge, Sn, Pb, Sb, Bi, Ag, Au, Zn, Cd, In, Ga, and the like can be used for example. Such elements have higher capacity than carbon. In particular, silicon has a significantly high theoretical capacity of 4200 mAh/g. For this reason, silicon is preferably used for the negative electrode active materials. Examples of the alloy-based material using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, for the negative electrode active materials, an oxide such as titanium dioxide (TiO₂), lithium titanium oxide (Li₄Ti₅O₁₂), lithium-graphite intercalation compound (Li_{X}C₆), niobium pentoxide (Nb₂O₅), tungsten oxide (WO₂), and molybdenum oxide (MoO₂) can be used.

Still alternatively, for the negative electrode active materials, Li_{3-X}M_{X}N (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active materials and thus the negative electrode active materials can be used in combination with a material for a positive electrode active material which does not contain lithium ions, such as V₂O₅ or Cr₃O₈. In the case of using a material containing lithium ions as a positive electrode active material, the nitride containing lithium and a transition metal can be used for the negative electrode active material by extracting the lithium ions contained in the positive electrode active material in advance.

Alternatively, a material which causes a conversion reaction can be used for the negative electrode active materials; for example, a transition metal oxide which does not cause an alloy reaction with lithium, such as cobalt oxide (CoO), nickel oxide (NiO), and iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The current collectors 305 and 308 can each be formed using a highly conductive material which is not alloyed with a carrier ion of lithium among other elements, such as a metal typified by stainless steel, gold, platinum, zinc, iron, nickel, copper, aluminum, titanium, and tantalum or an alloy thereof. Alternatively, an aluminum alloy to which an element which improves heat resistance, such as silicon, titanium, neodymium, scandium, and molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The current collectors can each have a foil-like shape, a plate-like shape (sheet-like shape), a net-like shape, a cylindrical shape, a coil shape, a punching-metal shape, an expanded-metal shape, or the like as appropriate. The current collectors each preferably have a thickness of 5 μm to 30 μm inclusive.

The positive electrode active materials described in the above embodiment can be used for the positive electrode active material layer 306.

As the separator 310, an insulator such as cellulose (paper), polyethylene with pores, and polypropylene with pores can be used.

As an electrolyte, a solid electrolyte, an electrolytic solution containing a supporting electrolyte, or a gel electrolyte obtained by gelation of part of an electrolytic solution can be used.

As the supporting electrolyte, a material which contains carrier ions is used. Typical examples of the supporting electrolyte are lithium salts such as LiPF₆, LiClO₄, LiAsF₆, LiBF₄, LiCF₃SO₃, Li(CF₃SO₂)₂N, and Li(C₂F₅SO₂)₂N. One of these supporting electrolytes may be used alone, or two or more of them may be used in an appropriate combination and in an appropriate ratio.

Note that when carrier ions are alkali metal ions other than lithium ions, alkaline-earth metal ions, beryllium ions, or magnesium ions, instead of lithium in the above lithium salts, an alkali metal (e.g., sodium and potassium), an alkaline-earth metal (e.g., calcium, strontium, barium, beryllium, and magnesium) may be used for the supporting electrolyte.

As a solvent of the electrolytic solution, a material with the carrier ion mobility is used. As the solvent of the electrolytic solution, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, tetrahydrofuran, and the like, and one or more of these materials can be used. When a gelled high-molecular material is used as the solvent of the electrolytic solution, safety against liquid leakage and the like is improved. Furthermore, the storage battery can be thinner and more lightweight. Typical examples of gelled high-molecular materials include a silicone gel, an acrylic gel, an acrylonitrile gel, polyethylene oxide, polypropylene oxide, a fluorine-based polymer, and the like. Alternatively, the use of one or more kinds of ionic liquids (room temperature molten salts) which have features of non-flammability and non-volatility as a solvent of the electrolytic solution can prevent the storage battery from exploding or catching fire even when the storage battery internally shorts out or the internal temperature increases owing to overcharging and others.

Instead of the electrolytic solution, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

For the positive electrode can 301 and the negative electrode can 302, a material having a corrosion-resistant property to an electrolytic solution, especially in charging and discharging, can be used. Such materials are, for example, a metal, an alloy, and a material covered with another material. Examples of metals include nickel, aluminum, and titanium. Examples of alloys include stainless steel. Examples of the covering materials include aluminum and nickel. The positive electrode can 301 and the negative electrode can 302 are electrically connected to the positive electrode 304 and the negative electrode 307, respectively.

The negative electrode 307, the positive electrode 304, and the separator 310 are immersed in the electrolytic solution. Then, as illustrated in FIG. 8B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type storage battery 300 can be manufactured.

Here, a current flow in charging a battery will be described with reference to FIG. 8C. When a battery using lithium is regarded as a closed circuit, lithium ions transfer and a current flows in the same direction. Note that in the battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the terms “anode” or “cathode” is used, it should be mentioned that the anode or the cathode is which of the one at the time of charging or the one at the time of discharging and corresponds to which of a positive electrode or a negative electrode.

Two terminals in FIG. 8C are connected to a charger, and a storage battery 400 is charged. As the charge of the storage battery 400 proceeds, a potential difference between electrodes increases. The positive direction in FIG. 8C is the direction in which a current flows from one terminal outside the storage battery 400 to a positive electrode 402, flows from the positive electrode 402 to a negative electrode 404 through an electrolyte 406 and a separator 408 in the storage battery 400, and flows from the negative electrode 404 to the other terminal outside the storage battery 400. In other words, a current flows in the direction of a flow of a charging current.

### [Laminated Storage Battery]

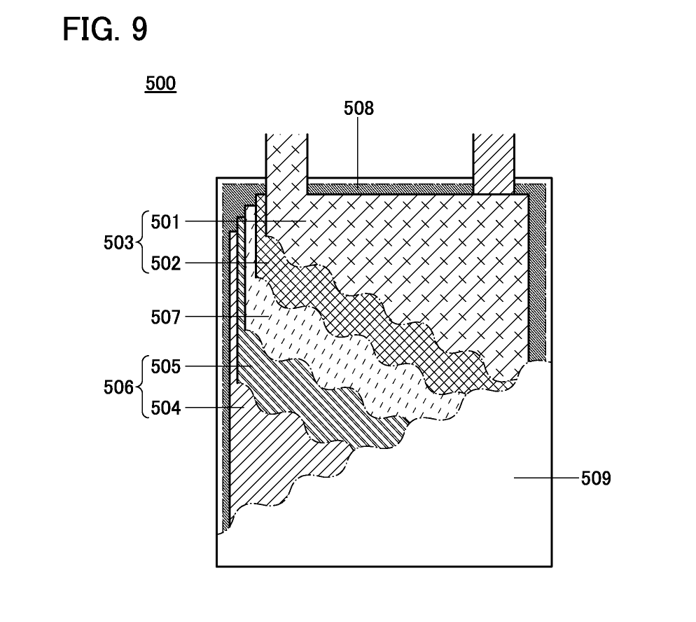

Next, an example of a laminated storage battery will be described with reference to FIG. 9.

A laminated storage battery 500 illustrated in FIG. 9 includes a positive electrode 503 including a positive electrode current collector 501 and a positive electrode active material layer 502, a negative electrode 506 including a negative electrode current collector 504 and a negative electrode active material layer 505, a separator 507, an electrolytic solution 508, and an exterior body 509. The separator 507 is provided between the positive electrode 503 and the negative electrode 506 in the exterior body 509. The electrolytic solution 508 is provided in the exterior body 509.

In the laminated storage battery 500 illustrated in FIG. 9, the positive electrode current collector 501 and the negative electrode current collector 504 also serve as terminals for an electrical contact with an external portion. For this reason, each of the positive electrode current collector 501 and the negative electrode current collector 504 is arranged so that part of the positive electrode current collector 501 and part of the negative electrode current collector 504 are exposed on the outside the exterior body 509.

As the exterior body 509 in the laminated storage battery 500, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used. With such a three-layer structure, permeation of the electrolytic solution and a gas can be blocked and an insulating property can be obtained.

### [Cylindrical Storage Battery]

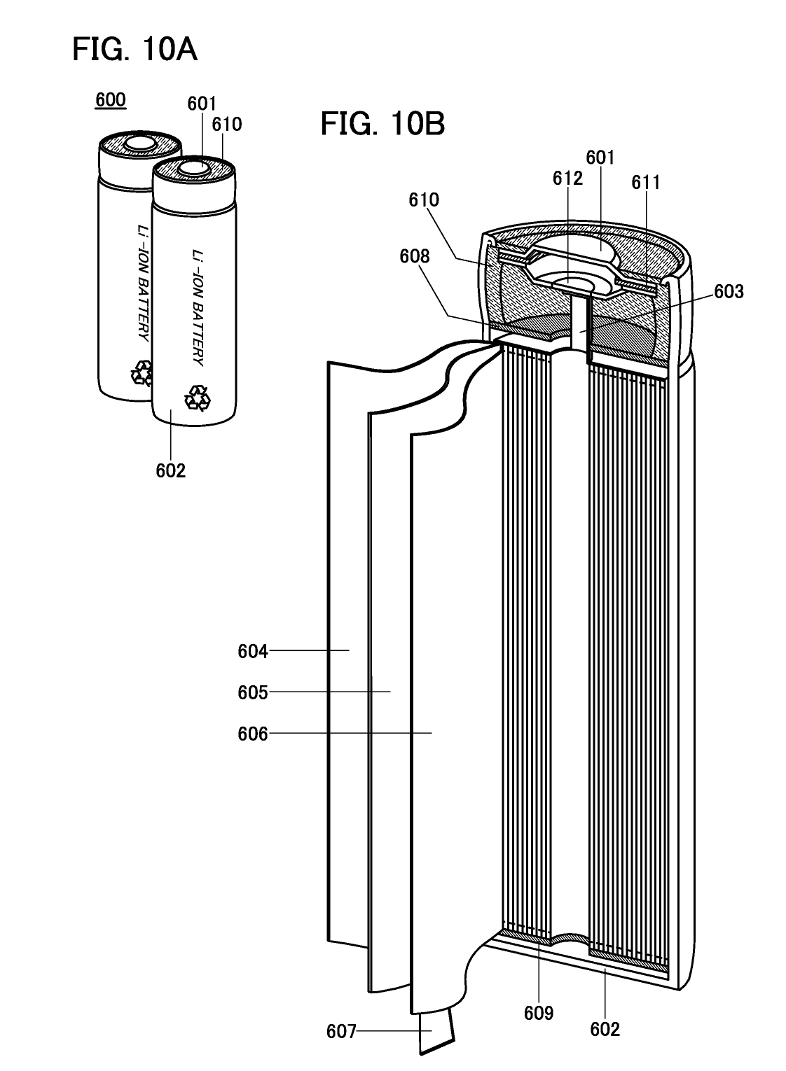

Next, an example of a cylindrical storage battery will be described with reference to FIGS. 10A and 10B. As illustrated in FIG. 10A, a cylindrical storage battery 600 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 10B is a diagram schematically illustrating a cross section of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. For the battery can 602, a material having corrosion resistance to an electrolytic solution, especially in charging and discharging, can be used. Such materials are, for example, a metal, an alloy, and a material covered with another material. Examples of metals include nickel, aluminum, and titanium. Examples of alloys include stainless steel. Examples of the covering materials include aluminum and nickel. Alternatively, the battery can 602 is preferably covered with nickel, aluminum, or the like in order to prevent corrosion caused by a nonaqueous electrolytic solution. Inside the battery can 602, the battery element in which the positive electrode, the negative electrode, and the separator are wound is provided between a pair of insulating plates 608 and 609 which face each other. Inside the battery can 602, the battery element in which the positive electrode, the negative electrode, and the separator are wound is interposed between a pair of insulating plates 608 and 609 which face each other. Furthermore, a nonaqueous electrolytic solution (not illustrated) is injected inside the battery can 602 provided with the battery element. As the nonaqueous electrolytic solution, a nonaqueous electrolytic solution which is similar to those of the above coin-type storage battery and the laminated power storage device can be used.

Although the positive electrode 604 and the negative electrode 606 can be formed in a manner similar to that of the positive electrode and the negative electrode of the coin-type storage battery described above, the difference lies in that, since the positive electrode and the negative electrode of the cylindrical storage battery are wound, active materials are formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

Note that in this embodiment, the coin-type storage battery, the laminated storage battery, and the cylindrical storage battery are given as examples of the storage battery; however, any of storage batteries with a variety of shapes, such as a sealed storage battery and a square-type storage battery, can be used. Furthermore, a structure in which a plurality of positive electrodes, a plurality of negative electrodes, and a plurality of separators are stacked or wound may be employed.

For each of the positive electrodes of the storage batteries 300, 500, and 600, which are described in this embodiment, the positive electrode active material of one embodiment of the present invention can be used. According to one embodiment of the present invention, the discharge capacity of the storage batteries 300, 500, and 600 can be increased.

This embodiment can be implemented in combination with any of the other embodiments as appropriate.

### Embodiment 5

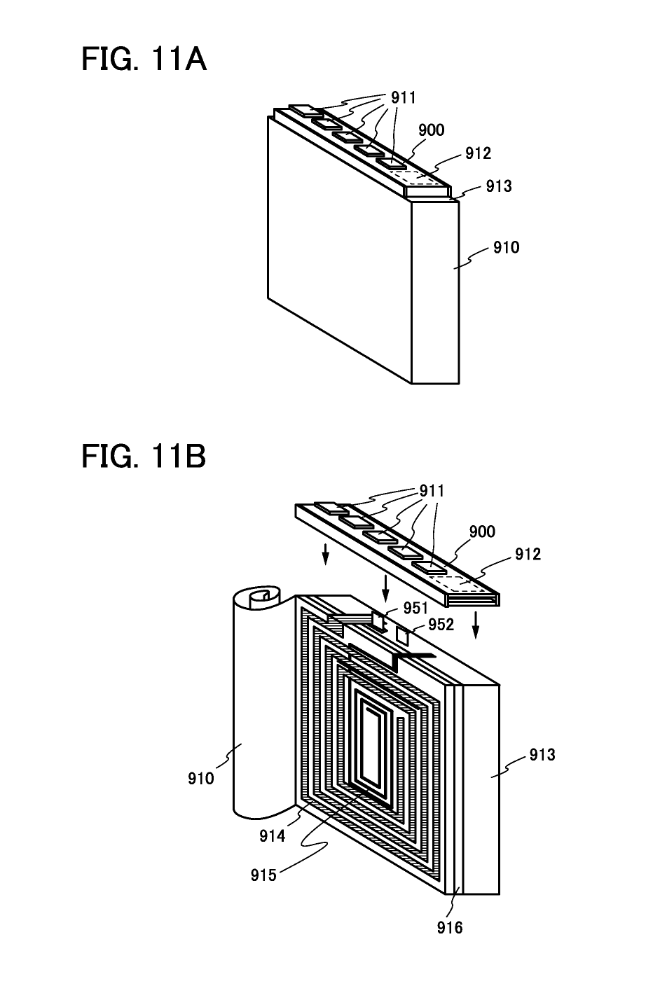

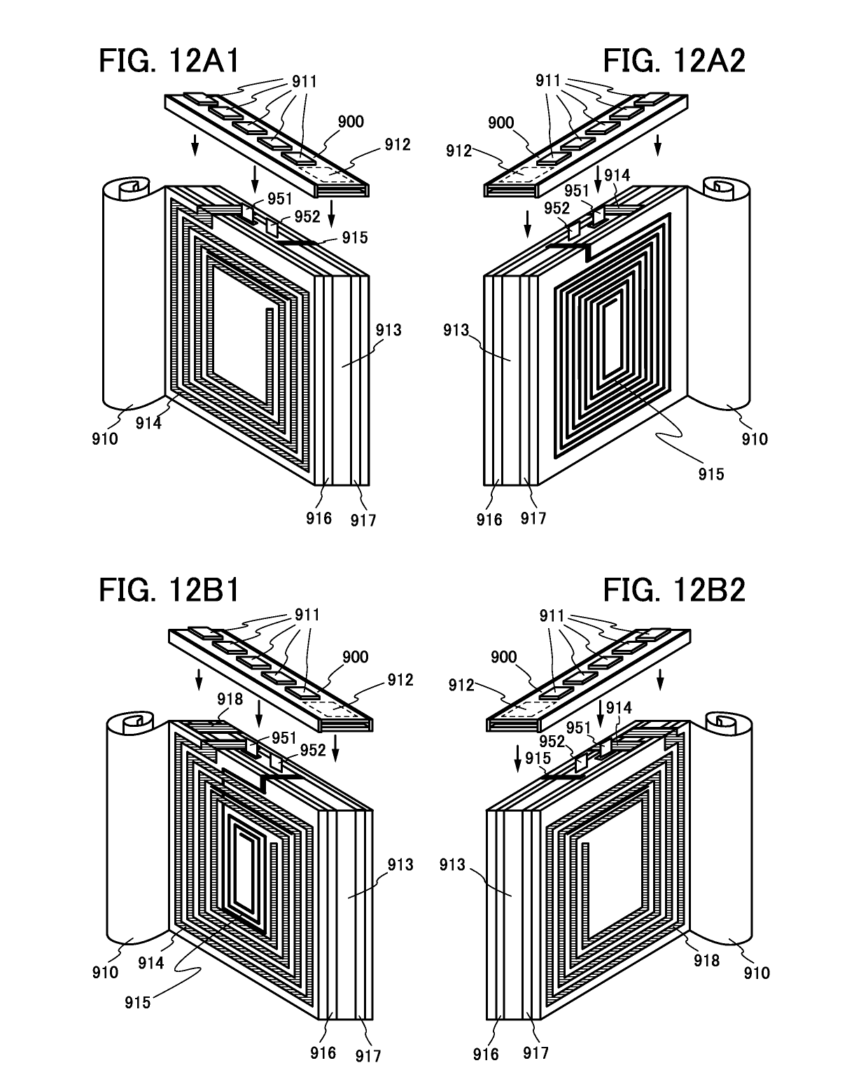

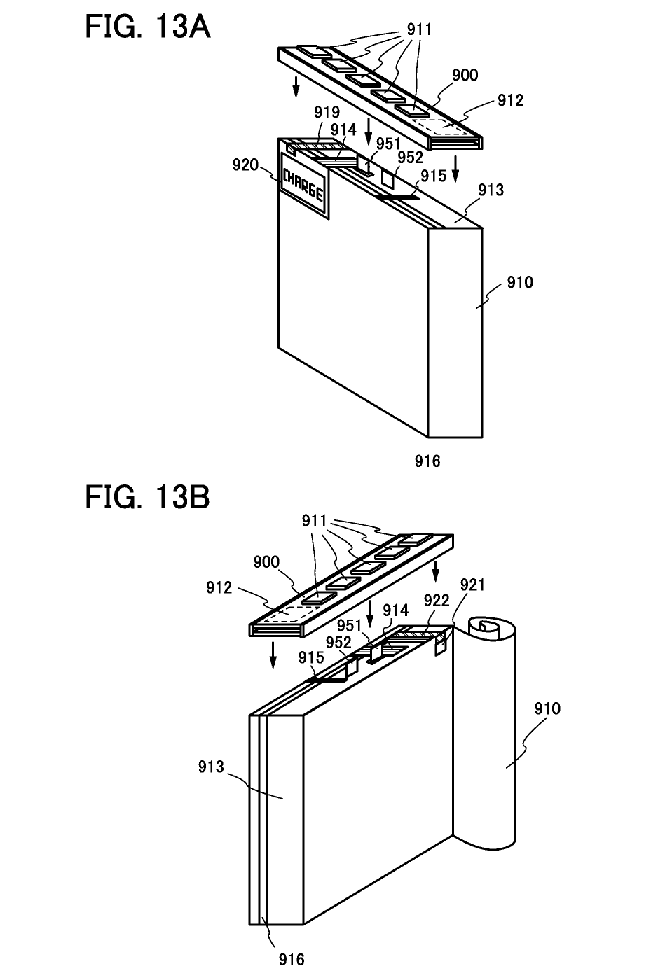

In this embodiment, structural examples of devices will be described with reference to FIGS. 11A and 11B, FIGS. 12A1, 12A2, 12B1, and 12B2, FIGS. 13A and 13B, FIGS. 14A and 14B, and FIG. 15.

FIGS. 11A and 11B are external views of a device. The device includes a circuit board 900 and a power storage unit 913. A label 910 is attached to the power storage unit 913. As shown in FIG. 11B, the device further includes a terminal 951 and a terminal 952, and includes an antenna 914 and an antenna 915 between the power storage unit 913 and the label 910.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. The shape of each of the antennas 914 and 915 is not limited to a coil shape and may be a linear shape or a plate shape. Further, a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, electric power can be transmitted and received not only by an electromagnetic field or a magnetic field but also by an electric field.

The positive electrode active material of the above embodiment can be used as a positive electrode active material of the power storage unit 913.

The line width of the antenna 914 is preferably larger than that of the antenna 915. This makes it possible to increase the amount of electric power received by the antenna 914.

The device includes a layer 916 between the power storage unit 913 and the antennas 914 and 915. The layer 916 may have a function of preventing an adverse effect on an electromagnetic field by the power storage unit 913. As the layer 916, for example, a magnetic body can be used.

Note that the structure of the device is not limited to that shown in FIGS. 11A and 11B.

For example, as shown in FIGS. 12A1 and 12A2, two opposite surfaces of the power storage unit 913 in FIGS. 11A and 11B may be provided with respective antennas. FIG. 12A1 is an external view showing one side of the opposite surfaces, and FIG. 12A2 is an external view showing the other side of the opposite surfaces. For portions similar to those in FIGS. 11A and 11B, a description of the device illustrated in FIGS. 11A and 11B can be referred to as appropriate.

As illustrated in FIG. 12A1, the antenna 914 is provided on one of the opposite surfaces of the power storage unit 913 with the layer 916 interposed therebetween, and as illustrated in FIG. 12A2, the antenna 915 is provided on the other of the opposite surfaces of the power storage unit 913 with a layer 917 interposed therebetween. The layer 917 may have a function of preventing an adverse effect on an electromagnetic field by the power storage unit 913. As the layer 917, for example, a magnetic body can be used.

With the above structure, both of the antennas 914 and 915 can be increased in size.

Alternatively, as illustrated in FIGS. 12B1 and 12B2, two opposite surfaces of the power storage unit 913 in FIGS. 11A and 11B may be provided with different types of antennas. FIG. 12B1 is an external view showing one side of the opposite surfaces, and FIG. 12B2 is an external view showing the other side of the opposite surfaces. For portions similar to those in FIGS. 11A and 11B, a description of the device illustrated in FIGS. 11A and 11B can be referred to as appropriate.

As illustrated in FIG. 12B1, the antenna 914 is provided on one of the opposite surfaces of the power storage unit 913 with the layer 916 interposed therebetween, and as illustrated in FIG. 12B2, an antenna 918 is provided on the other of the opposite surfaces of the power storage unit 913 with the layer 917 interposed therebetween. The antenna 918 has a function of communicating data with an external device, for example. An antenna with a shape that can be applied to the antennas 914 and 915, for example, can be used as the antenna 918. As a system for communication using the antenna 918 between the device and another device, a response method that can be used between the device and the device 200, such as NFC, can be employed.

Alternatively, as illustrated in FIG. 13A, the power storage unit 913 in FIGS. 11A and 11B may be provided with a display device 920. The display device 920 is electrically connected to the terminal 911 via a terminal 919. It is possible that the label 910 is not provided in a portion where the display device 920 is provided. For portions similar to those in FIGS. 11A and 11B, a description of the device illustrated in FIGS. 11A and 11B can be referred to as appropriate.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 13B, the power storage unit 913 illustrated in FIGS. 11A and 11B may be provided with a sensor 921. The sensor 921 is electrically connected to the terminal 911 via a terminal 922. Note that the sensor 921 may be provided between the power storage unit 913 and the label 910. For portions similar to those in FIGS. 11A and 11B, a description of the device illustrated in FIGS. 11A and 11B can be referred to as appropriate.

As the sensor 921, for example, a sensor that can be used as the sensor 235 can be used. Accordingly, the sensor 921 may be used as the sensor 235. With the sensor 921, for example, data on an environment (e.g., temperature) where the device is placed can be determined and stored in a memory inside the circuit 912.

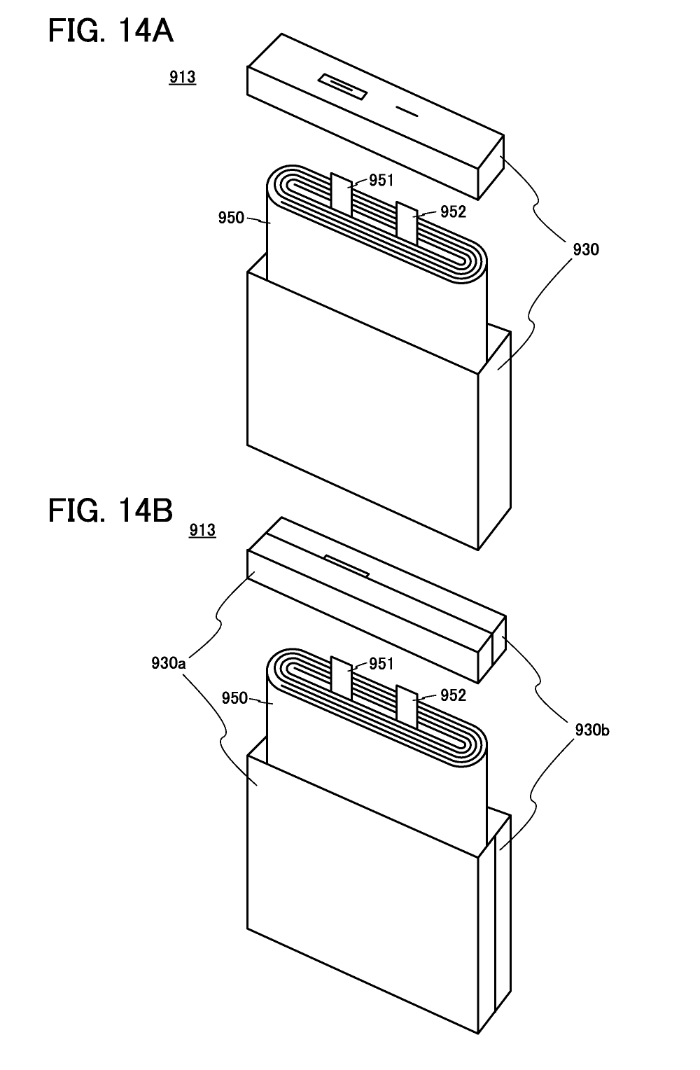

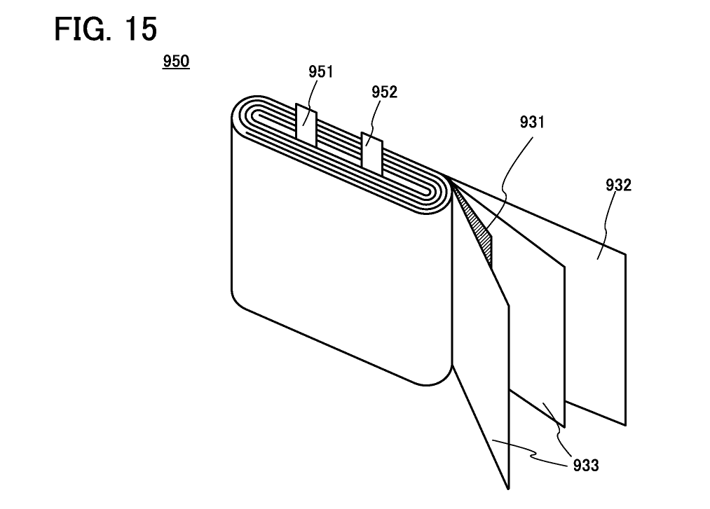

Furthermore, structural examples of the power storage unit 913 will be described with reference to FIGS. 14A and 14B and FIG. 15.

The power storage unit 913 illustrated in FIG. 14A includes a wound body 950 provided with the terminals 951 and 952 inside a housing 930. The wound body 950 is soaked in an electrolytic solution inside the housing 930. The terminal 952 is in contact with the housing 930. An insulator or the like prevents contact between the terminal 951 and the housing 930. Note that in FIG. 14A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the power storage unit 913 in FIG. 14B, a housing 930a and a housing 930b are bonded to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the power storage unit 913 can be prevented. When an electric field is not significantly blocked by the housing 930a, an antenna such as the antennas 914 and 915 may be provided inside the housing 930. For the housing 930b, a metal material can be used, for example.

FIG. 15 illustrates the structure of the wound body 950. The wound body 950 includes a negative electrode 931, a positive electrode 932, and a separator 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be stacked.

The negative electrode 931 is connected to the terminal 911 in FIGS. 11A and 11B via one of the terminals 951 and 952. The positive electrode 932 is connected to the terminal 911 in FIGS. 11A and 11B via the other of the terminals 951 and 952.

This embodiment can be implemented in combination with any of the other embodiments as appropriate.

### Embodiment 6

In this embodiment, electrical appliances will be described.

Here, “electrical appliances” refer to general industrial products including portions which operate by electric power. Electrical appliances are not limited to consumer products such as home electrical products and also include products for various uses such as business use, industrial use, and military use in their category.

Examples of electrical appliances for each of which the power storage device of one embodiment of the present invention can be used are as follows: display devices of televisions, monitors, and the like, lighting devices, desktop personal computers, laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, remote controls, clocks such as table clocks and wall clocks, cordless phone handsets, transceivers, portable wireless devices, mobile phones, car phones, portable or stationary game machines, pedometers, calculators, portable information terminals, electronic notebooks, e-book readers, electronic translators, audio input devices such as microphones, cameras such as still cameras and video cameras, toys, electric shavers, electric toothbrushes, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, power tools, smoke detectors, and a health equipment and a medical equipment such as hearing aids, cardiac pacemakers, portable X-ray equipment, radiation counters, electric massagers, and dialyzers. The examples also include industrial equipment such as guide lights, traffic lights, meters such as gas meters and water meters, belt conveyors, elevators, escalators, automatic vending machines, automatic ticket machine, cash dispensers (CD), automated teller machines (ATM), digital signage, industrial robots, radio relay stations, mobile phone base stations, power storage systems, and secondary batteries for leveling the amount of power supply and smart grid. In addition, moving objects (transporter) driven by electric motors using electric power from secondary batteries are also included in the category of electrical appliances. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, agricultural machines, motorized bicycles including motor-assisted bicycles, motorcycles, electrical wheelchairs, electrical carts, boats, ships, submarines, aircrafts such as fixed-wing aircraft and rotary-wing aircraft, rockets, artificial satellites, space probes, planetary probes, and spacecrafts.

Note that in the electrical appliances, the power storage device of one embodiment of the present invention can be used as main power sources for supplying enough electric power for almost the whole power consumption. Alternatively, for the electrical appliances, the power storage device of one embodiment of the present invention can be used as an uninterruptible power source which can supply power to the electrical appliances when the supply of power from the main power sources or a commercial power source is stopped. Still alternatively, for the electrical appliances, a nonaqueous secondary battery of one embodiment of the present invention can be used as an auxiliary power source for supplying electric power to the electrical appliances at the same time as the electrical appliances are supplied with electric power from the main power sources or the commercial power source.

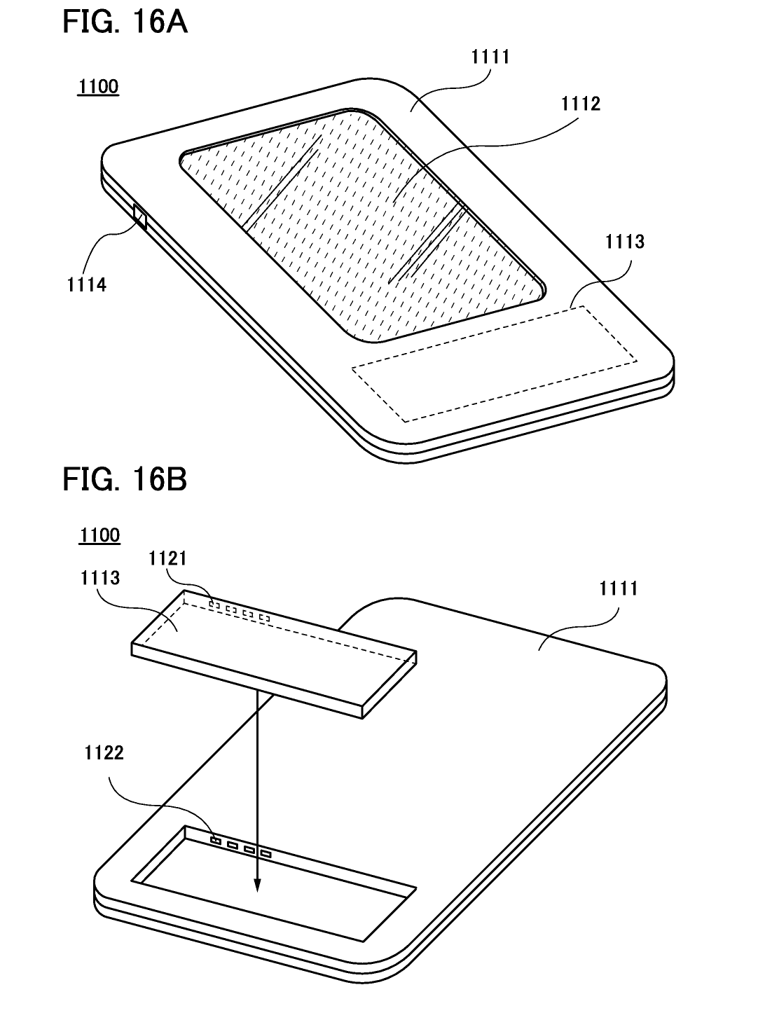

FIGS. 16A and 16B illustrate a portable terminal as an example of an electrical appliance. FIG. 16A illustrates the front side of the portable terminal and FIG. 16B illustrates the rear side of the portable terminal.

A portable terminal 1100 illustrated in FIGS. 16A and 16B includes a housing 1111, a display portion 1112, a power storage device 1113, and a power switch 1114.

Part of the display portion 1112 can be a touch panel region, and data can be input by touching operation keys that are displayed. Although a structure in which a half region in the display portion 1112 has only a display function and the other half region also has a touch panel function is illustrated as an example, the structure of the display portion 1112 is not limited thereto. The whole display portion 1112 may have a touch panel function.

As the display portion 1112, for example, an electroluminescent (EL) display module or a liquid crystal display module can be used.

The power storage device 1113 is a cassette-type battery. The power storage device 1113 includes terminals 1121, and there is no particular limitation on the number of the terminals 1121. When the power storage device 1113 is embedded in a depressed portion of the housing 1111, the terminals 1121 are connected to terminals 1122 provided on the housing 1111. Thus, power can be supplied to circuits inside the housing 1111 from the power storage device 1113. Note that the power storage device 1113 embedded in the depressed portion of the housing 1111 may be exposed, or a cover may be provided over the power storage device 1113. Here, the power storage device 1113 can be detached from the portable terminal 1100; however, one embodiment of the present invention is not limited thereto. It is possible that a user of the portable terminal 1100 is not allowed to detach the power storage device 1113. With such a structure, flexibility of the layout of components inside the portable terminal 1100 is increased, so that the portable terminal 1100 can be reduced in size and thickness. In this case, power can be transmitted and received with the power storage device 1113 placed inside the portable terminal 1100. Note that even in the case where the power storage device 1113 is detachable from the portable terminal 1100, power may be transmitted and received with the power storage device 1113 placed inside the portable terminal 1100.

The portable terminal illustrated in FIGS. 16A and 16B can have a function of displaying various kinds of data (e.g., a still image, a moving image, and a text image), a function of displaying a calendar, the date, the time, or the like on the display portion, a touch-input function of operating or editing data displayed on the display portion by touch input, and a function of controlling processing by various kinds of software (programs), for example.

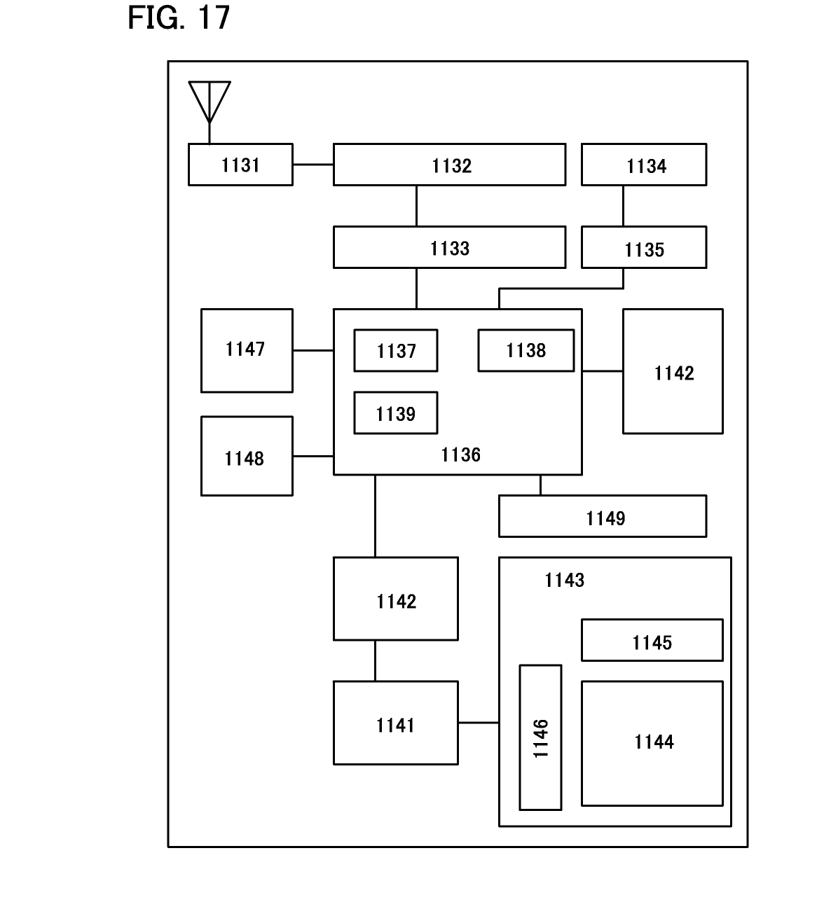

FIG. 17 is a block diagram illustrating an example of a portable terminal. The portable terminal illustrated in FIG. 17 includes, for example, a wireless communication circuit 1131, an analog baseband circuit 1132, a digital baseband circuit 1133, a power storage device 1134, a power supply circuit 1135, an application processor 1136, a display controller 1141, a memory 1142, a display 1143, a touch sensor 1149, an audio circuit 1147 (such as a speaker or a microphone), and a keyboard 1148 that is one of input means.

The power storage device 1134 corresponds to the power storage device 1113 in FIGS. 16A and 16B, and other components correspond to a load.

The wireless communication circuit 1131 has a function of receiving radio waves including data, for example. For example, an antenna or the like is used as the wireless communication circuit 1131.

With the touch sensor 1149, a display portion 1144 of the display 1143 can be operated.

The display 1143 includes the display portion 1144, a source driver 1145, and a gate driver 1146. Operation of the display portion 1144 is controlled by the source driver 1145 and the gate driver 1146.

The application processor 1136 includes a CPU 1137, a digital signal processor (also referred to as a DSP) 1138, and an interface (also referred to as an IF) 1139.

The memory 1142 usually includes an SRAM or a DRAM.

An operation example of the portable terminal illustrated in FIG. 17 will be described.

First, an image is formed as a result of reception of radio waves including data, or by the application processor 1136. The data stored in the memory 1142 is output to the display 1143 through the display controller 1141 and an image based on the input image data is displayed by the display 1143. In the case where the image is not changed, the data is read from the memory 1142 at a frequency of, usually, higher than or equal to 60 Hz and lower than or equal to 130 Hz, and the read data is continuously transmitted to the display controller 1141. In the case where the user carries out operation of rewriting the image, a new image is formed by the application processor 1136, and the image is stored in the memory 1142. The stored image data is read periodically from the memory 1142 even during that time. After the new image data is stored in the memory 1142, in the next frame period for the display 1143, the data stored in the memory 1142 is read and the read data is output to the display 1143 through the display controller 1141. The display 1143 to which the data is input displays an image based on the input image data. The above read operation is repeated until when next data is stored in the memory 1142. Data is written to and read from the memory 1142 in this manner, whereby the display 1143 displays an image.

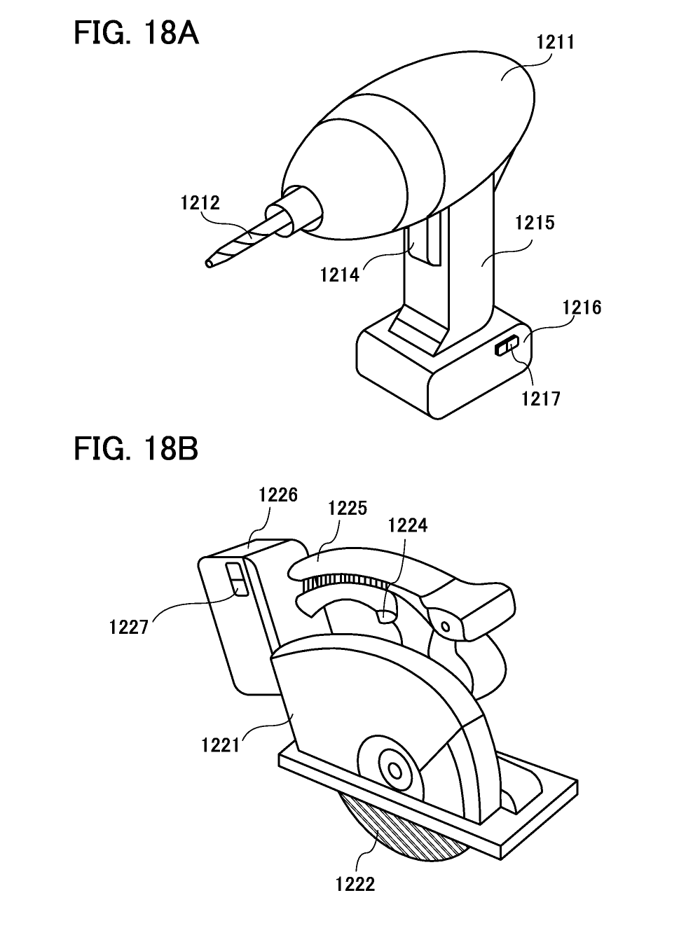

FIGS. 18A and 18B each illustrate an example of a power tool.

The power tool in FIG. 18A includes a housing 1211, a tip tool 1212, a trigger switch 1214, a power storage device 1216, and an attachment/detachment switch 1217. Note that the power tool in FIG. 18A may be an electric drill or an electric driver.

The housing 1211 includes a handle portion 1215.

As the tip tool 1212, for example, a drill, a plus driver bit, or a minus driver bit can be used. Note that the tip tool 1212 may be made detachable and any of a drill, a plus driver bit, and a minus driver bit may be used in accordance with the purpose.

In the case of the power tool in FIG. 18A, a power switch 1213 is turned on, the handle portion 1215 is gripped, and the trigger switch 1214 is turned on, whereby the tip tool 1212 can be operated.

The power storage device 1216 can be attached and detached by turning on or off the attachment/detachment switch 1217. The power storage device 1216 has terminals as in the portable terminal shown in FIGS. 16A and 16B. When the terminals of the power storage device 1216 are connected to terminals provided on the housing 1211, power can be supplied to the housing 1211 from the power storage device 1216.

The power tool in FIG. 18B includes a housing 1221, a blade 1222, a trigger switch 1224, a power storage device 1226, and an attachment/detachment switch 1227. Note that the power tool in FIG. 18B may be an electric cutter.

The housing 1221 includes a handle portion 1225.

In the case of the power tool in FIG. 18B, the handle portion 1225 is gripped and the trigger switch 1224 is turned on, whereby the blade 1222 rotates and cutting operation or the like can be performed.

The power storage device 1226 can be attached and detached by turning on or off the attachment/detachment switch 1227. The power storage device 1226 has terminals as in the portable terminal shown in FIGS. 16A and 16B. When the terminals of the power storage device 1226 are connected to terminals provided on the housing 1221, power can be supplied to the housing 1221 from the power storage device 1226.

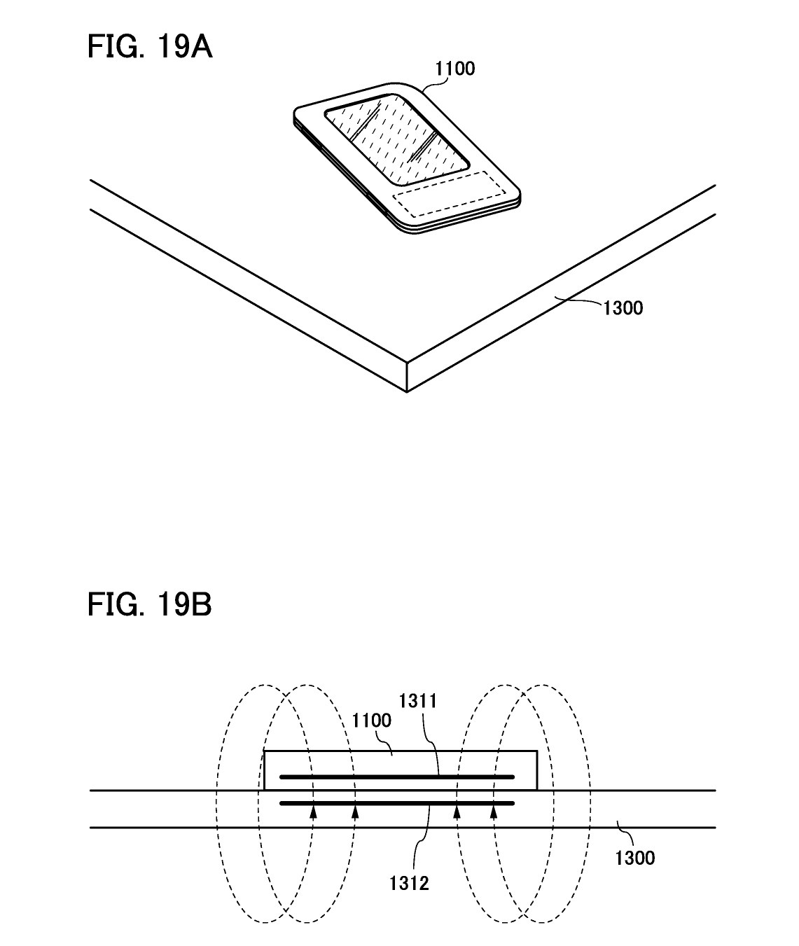

An example of charging the above electrical appliance will be described with reference to FIGS. 19A and 19B.

FIG. 19A shows an example where the portable terminal 1100 shown in FIGS. 16A and 16B is placed over a power feeding device 1300.

In FIG. 19B, the portable terminal is viewed from the bottom side. For example, when an electromagnetic induction method is used, as shown in FIG. 19B, an antenna 1311 provided for the portable terminal 1100 and an antenna 1312 provided for the power feeding device 1300 are electromagnetically coupled to form a power transmission transformer, whereby power can be supplied to the portable terminal 1100.

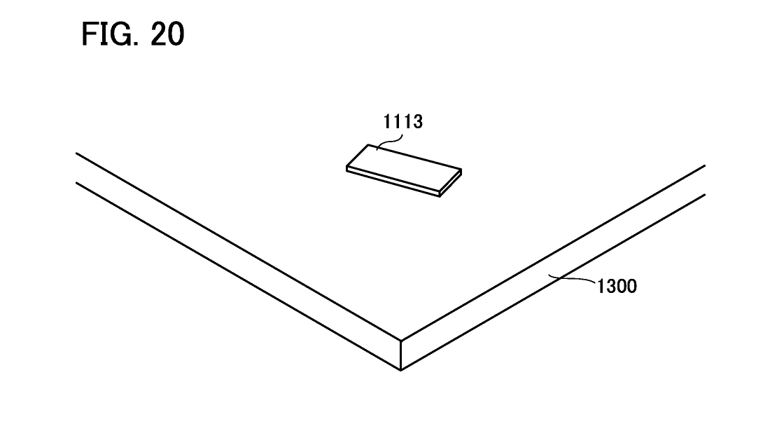

Although FIGS. 19A and 19B illustrate an example where the portable terminal 1100 is placed over the power feeding device 1300, the power storage device 1113 may be detached from the portable terminal 1100 and placed over the power feeding device 1300 as shown in FIG. 20.

There is no particular limitation on the structure of the power feeding device 1300. For example, a moving coil method in which the location of the portable terminal 1100 is determined and the antenna 1312 is moved so as to overlap with the portable terminal 1100 and charging of the portable terminal 1100 is performed, a multi-coil method in which a plurality of antennas 1312 is provided and charging is performed with the antenna 1312 that overlaps with the portable terminal 1100, or the like may be used.

Electrical appliances which can be charged by the power feeding device 1300 are not limited to the above.

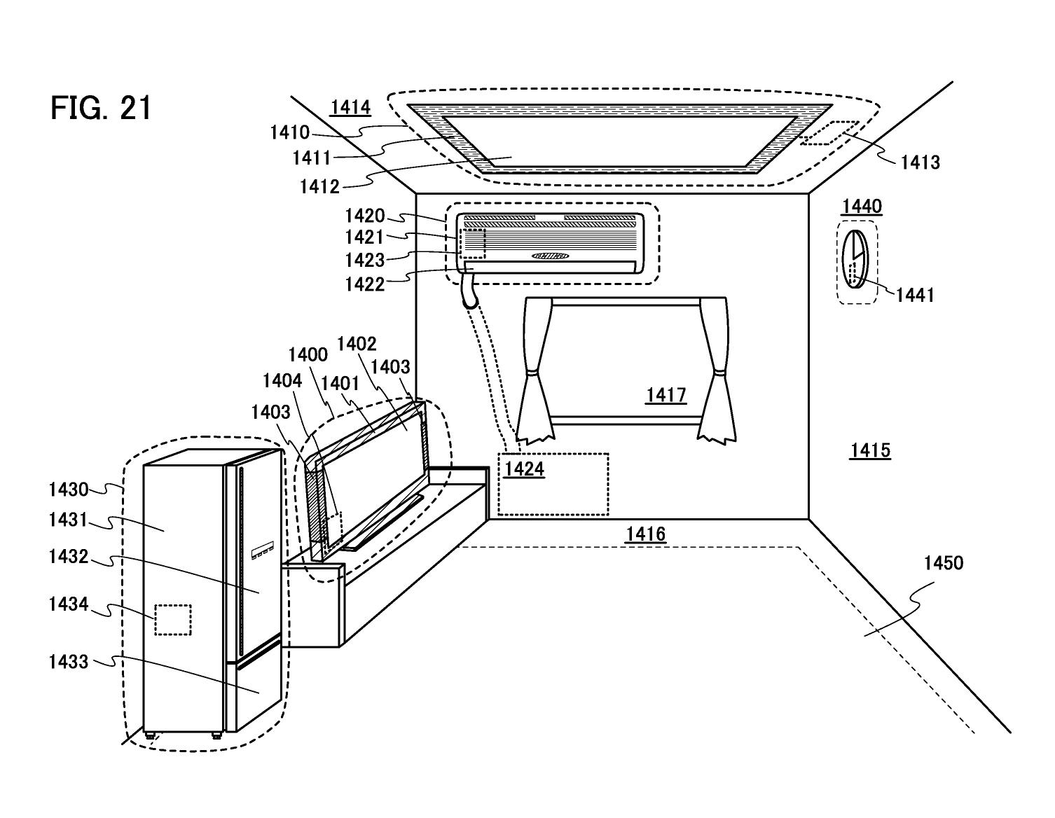

FIG. 21 illustrates specific structures of the electrical appliances. In FIG. 21, a display device 1400 that can be supplied with electric power from a power feeding device 1450 is an example of an electrical appliance including a power storage device 1404 of one embodiment of the present invention. Specifically, the display device 1400 corresponds to a display device for TV broadcast reception and includes a housing 1401, a display portion 1402, speaker portions 1403, and the power storage device 1404. The power storage device 1404 of one embodiment of the present invention is provided in the housing 1401. The display device 1400 can receive electric power from a commercial power supply. Alternatively, the display device 1400 can use electric power stored in the power storage device 1404 including the storage battery electrode of one embodiment of the present invention. Thus, the display device 1400 can be operated with the use of the power storage device 1404 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 1402.

Note that the display device includes, in its category, all of information display devices for personal computers, advertisement displays, and the like besides TV broadcast reception.

In FIG. 21, an installation lighting device 1410 that can be supplied with electric power from the power feeding device 1450 is an example of an electrical appliance including a power storage device 1413 of one embodiment of the present invention. Specifically, the lighting device 1410 includes a housing 1411, a light source 1412, and the power storage device 1413. Electric power is supplied to the power storage device 1413 via the power feeding device 1450. Although FIG. 21 illustrates the case where the power storage device 1413 is provided in a ceiling 1414 on which the housing 1411 and the light source 1412 are installed, the power storage device 1413 may be provided in the housing 1411. The lighting device 1410 can receive electric power from a commercial power supply. Alternatively, the lighting device 1410 can use electric power stored in the power storage device 1413. Thus, the lighting device 1410 can be operated with the use of power storage device 1413 of one embodiment of the present invention as an uninterruptible power supply even when electric power cannot be supplied from a commercial power supply due to power failure or the like.

Note that although the installation lighting device 1410 provided in the ceiling 1414 is illustrated in FIG. 21 as an example, the power storage device of one embodiment of the present invention can be used in an installation lighting device provided in, for example, a wall 1415, a floor 1416, a window 1417, or the like other than the ceiling 1414. Alternatively, the storage battery including the electrode of one embodiment of the present invention can be used in a tabletop lighting device or the like.

As the light source 1412, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 21, an air conditioner that includes an indoor unit 1420 and an outdoor unit 1424 and can be supplied with electric power from the power feeding device 1450 is an example of an electrical appliance including a power storage device 1423 of one embodiment of the present invention. Specifically, the indoor unit 1420 includes a housing 1421, an air outlet 1422, and the power storage device 1423. Although FIG. 21 illustrates the case where the power storage device 1423 is provided in the indoor unit 1420, the power storage device 1423 may be provided in the outdoor unit 1424. Alternatively, the power storage devices 1423 may be provided in both the indoor unit 1420 and the outdoor unit 1424. The air conditioner can receive electric power from a commercial power supply. Alternatively, the air conditioner can use electric power stored in the power storage device 1423. Particularly in the case where the power storage devices 1423 are provided in both the indoor unit 1420 and the outdoor unit 1424, the air conditioner can be operated with the use of the power storage device 1423 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 21 as an example, the power storage device of one embodiment of the present invention can be used in an air conditioner in which the functions of an indoor unit and an outdoor unit are integrated in one housing.

In FIG. 21, an electric refrigerator-freezer 1430 that can be supplied with electric power from the power feeding device 1450 is an example of an electrical appliance including a power storage device 1434 of one embodiment of the present invention. Specifically, the electric refrigerator-freezer 1430 includes a housing 1431, a door for a refrigerator 1432, a door for a freezer 1433, and the power storage device 1434. The power storage device 1434 is provided in the housing 1431 in FIG. 21. The electric refrigerator-freezer 1430 can receive electric power from a commercial power supply. Alternatively, the electric refrigerator-freezer 1430 can use electric power stored in the power storage device 1434. Thus, the electric refrigerator-freezer 1430 can be operated with the use of the power storage device 1434 of one embodiment of the present invention as an uninterruptible power supply even when electric power cannot be supplied from a commercial power supply due to power failure or the like.

In FIG. 21, a clock 1440 that can be supplied with electric power from the power feeding device 1450 is an example of an electrical appliance including a power storage device 1441 of one embodiment of the present invention.

Note that among the electrical appliances described above, a high-frequency heating apparatus such as a microwave oven and an electrical appliance such as an electric rice cooker require high power in a short time. The tripping of a breaker of a commercial power supply in use of an electrical appliance can be prevented by using the power storage device of one embodiment of the present invention as an auxiliary power supply for supplying electric power which cannot be supplied enough by a commercial power supply.

In addition, in a time period when electrical appliances are not used, particularly when the percentage of the amount of electric power which is actually used to the total amount of electric power which can be supplied from a commercial power supply source (such a percentage referred to as a usage rate of electric power) is low, electric power can be stored in the power storage device, whereby the usage rate of electric power can be reduced in a time period when the electrical appliances are used. For example, in the case of the electric refrigerator-freezer 1430, electric power can be stored in the power storage device 1434 in night time when the temperature is low and the door for a refrigerator 1432 and the door for a freezer 1433 are not often opened or closed. On the other hand, in daytime when the temperature is high and the door for a refrigerator 1432 and the door for a freezer 1433 are frequently opened and closed, the power storage device 1434 is used as an auxiliary power supply; thus, the usage rate of electric power in daytime can be reduced.

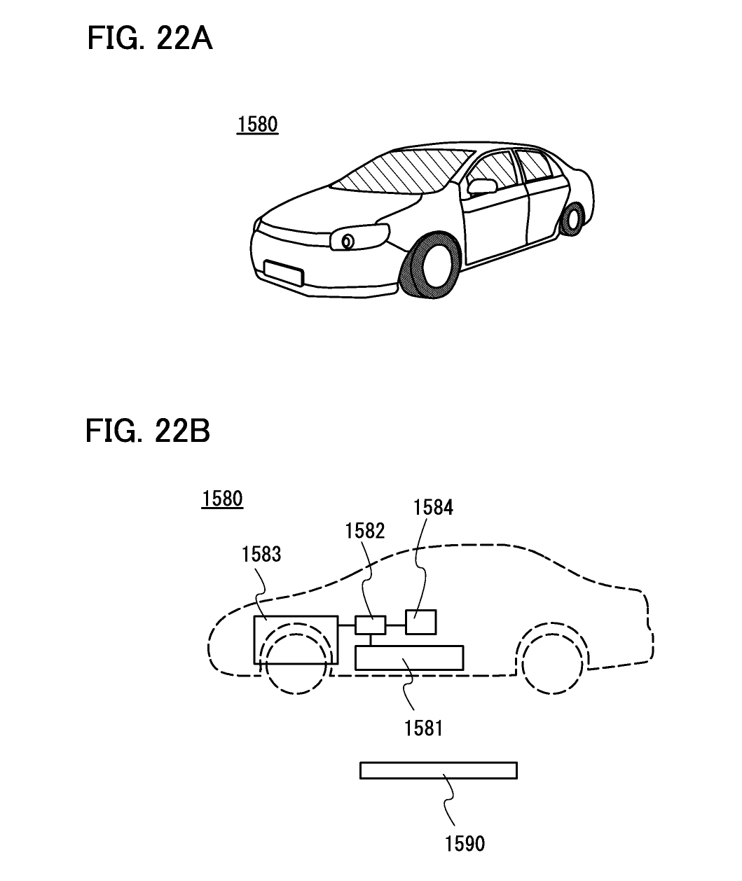

An example of the moving object, which is an example of the electrical appliance, will be described with reference to FIGS. 22A and 22B.

The power storage device described in the above embodiment can be used as a power storage device for controlling the moving object. The power storage device for controlling the moving object can be externally charged by electric power supply using a plug-in system or contactless power feeding. Note that in the case where the moving object is an electric railway vehicle, the electric railway vehicle can be charged by electric power supply from an overhead cable or a conductor rail.

FIGS. 22A and 22B illustrate an example of an electric vehicle which can be supplied with electric power from power feeding equipment 1590. An electric vehicle 1580 is equipped with a power storage device 1581 of one embodiment of the present invention. Electric power is supplied from the power feeding equipment 1590 to the power storage device 1581. The output of electric power of the power storage device 1581 is controlled by a control circuit 1582 and the electric power is supplied to a driving device 1583. The control circuit 1582 is controlled by a processing unit 1584 including a ROM, a RAM, a CPU, or the like which is not illustrated.

The driving device 1583 includes a DC motor or an AC motor either alone or in combination with an internal-combustion engine. The processing unit 1584 outputs a control signal to the control circuit 1582 on the basis of input data such as data of operation (e.g., acceleration, deceleration, or stop) by a driver or data during driving (e.g., data on an upgrade or a downgrade, or data on a load on a driving wheel) of the electric vehicle 1580. The control circuit 1582 adjusts the electric energy supplied from the power storage device 1581 in response to the control signal of the processing unit 1584 to control the output of the driving device 1583. In the case where the AC motor is mounted, although not illustrated, an inverter, which converts direct current into alternate current, is also incorporated.

The power storage device 1581 can be charged with electric power supplied from the power feeding equipment 1590. The power storage device 1581 can be charged by converting the supplied power into DC constant voltage having a predetermined voltage level through a converter such as an AC-DC converter. When the power storage device of one embodiment of the present invention is provided as the power storage device 1581, capacity of the battery can be increased and convenience can be improved.

Note that a plurality of power storage devices can be charged by one power feeding device 1450. For example, the power feeding device 1450 can transmit inquiry signals to electrical appliances wirelessly and sequentially feed electric power to the electrical appliances in response to response signals from the electrical appliances. In that case, each power storage device may have an anti-collision function so that the power storage devices can respond to radio waves received from the power feeding device 1450 at different timings. For example, in the case where the power storage devices have different identification data, the power storage device which is to respond can be selected in accordance with the identification data. Therefore, the power storage devices can respond at different timings. Thus, for example, in the case where the power feeding device 1450 has a plurality of oscillation circuits, the power feeding device 1450 can sequentially feed electric power to a plurality of power storage devices by individually controlling the oscillation circuits. Alternatively, the power feeding device 1450 can feed electric power to the power storage devices concurrently.

As described above, the power storage device of one embodiment of the present invention can be applied to a variety of electrical appliances. This embodiment can be implemented in combination with any of the other embodiments as appropriate.

### EXPLANATION OF REFERENCE

100: comparative sample, 101: sample, 116: sample, 150: part, 200: device, 201: sample, 235: sensor, 300: storage battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: storage battery, 402: positive electrode, 404: negative electrode, 406: electrolyte, 408: separator, 500: storage battery, 501: positive electrode current collector, 502: positive electrode active material layer, 503: positive electrode, 504: negative electrode current collector, 505: negative electrode active material layer, 506: negative electrode, 507: separator, 508: electrolytic solution, 509: exterior body, 600: storage battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 700: comparative sample, 701: sample, 900: circuit board, 910: label, 911: terminal, 912: circuit, 913: power storage unit, 914: antenna, 915: antenna, 916: layer, 917: layer, 918: antenna, 919: terminal, 920: display device, 921: sensor, 922: terminal, 930: housing, 931: negative electrode, 932: positive electrode, 933: separator, 950: wound body, 951: terminal, 952: terminal, 1100: portable terminal, 1111: housing, 1112: display portion, 1113: power storage device, 1114: power switch, 1121: terminal, 1122: terminal, 1131: wireless communication circuit, 1132: analog baseband circuit, 1133: digital baseband circuit, 1134: power storage device, 1135: power supply circuit, 1136: application processor, 1137: CPU, 1140: memory, 1141: display controller, 1142: memory, 1143: display, 1144: display portion, 1145: source driver, 1146: gate driver, 1148: keyboard, 1149: touch sensor, 1211: housing, 1212: tip tool, 1213: power switch, 1214: trigger switch, 1215: handle portion, 1216: power storage device, 1217: attachment/detachment switch, 1221: housing, 1222: blade, 1224: trigger switch, 1225: handle portion, 1226: power storage device, 1227: attachment/detachment switch, 1300: power feeding device, 1311: antenna, 1312: antenna, 1400: display device, 1401: housing, 1402: display portion, 1403: speaker portion, 1404: power storage device, 1410: lighting device, 1411: housing, 1412: light source, 1413: power storage device, 1414: ceiling, 1415: wall, 1416: floor, 1417: window, 1420: indoor unit, 1421: housing, 1422: air outlet, 1423: power storage device, 1424: outdoor unit, 1430: electric refrigerator-freezer, 1431: housing, 1432: door for refrigerator, 1433: door for freezer, 1434: power storage device, 1440: clock, 1441: power storage device, 1450: power feeding device, 1580: electric vehicle, 1581: power storage device, 1582: control circuit, 1583: driving device, 1584: processing unit, 1590: power feeding device, 151a: curve, 151b: curve, 700a: curve, 700b: curve, 930a: housing, 930b: housing

This application is based on Japanese Patent Application serial no. 2013-147169 filed with Japan Patent Office on Jul. 15, 2013 and Japanese Patent Application serial no. 2013-172853 filed with Japan Patent Office on Aug. 23, 2013, the entire contents of which are hereby incorporated by reference.

1. An active material comprising:
a material represented by Li₂Mn_{1-X}A_{X}O₃,
wherein A is at least one of Si, P and a metal element other than Li and Mn, and
wherein X is greater than 0 and less than 1.

2. The active material according to claim 1, wherein A is at least one of Ni, Ga, Fe, Mo, In, Nb, Nd, Co, Sm, Mg, Al, Ti, Cu, Zn, Si and P.

3. The active material according to claim 2, wherein A is Ni.

4. The active material according to claim 1, wherein the material represented by Li₂Mn_{1-X}A_{X}O₃ is a main component of the active material.

5. The active material according to claim 1, wherein X is greater than or equal to 0.01 and less than or equal to 0.3.

6. An electrode comprising the active material according to claim 1.

7. A secondary battery comprising the electrode according to claim 6.

8. An electrical appliance comprising the secondary battery according to claim 7.

9. An active material comprising:
a material represented by Li_{Y}Mn_{1-X}A_{X}O₃,
wherein A is at least one of Si, P and a metal element other than Li and Mn,
wherein X is greater than 0 and less than 1, and
wherein Y is 0 or more and 2 or less.

10. The active material according to claim 9, wherein A is at least one of Ni, Ga, Fe, Mo, In, Nb, Nd, Co, Sm, Mg, Al, Ti, Cu, Zn, Si and P.

11. The active material according to claim 10, wherein A is Ni.

12. The active material according to claim 9, wherein the material represented by Li_{Y}Mn_{1-X}AₓO₃ is a main component of the active material.

13. The active material according to claim 9, wherein X is greater than or equal to 0.01 and less than or equal to 0.3.

14. An electrode comprising the active material according to claim 9.

15. A secondary battery comprising the electrode according to claim 14.

16. An electrical appliance comprising the secondary battery according to claim 15.
